(19) United States
(12) Patent Application Publication
(10) Pub. No.: US 2002/0120493 A1
(43) Pub. Date: Aug. 29, 2002

(54) Flexographic platemaker project management and customer interface system

(76) Inventor: Robert A. Mormile, Wallingford, PA (US)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 09/792,118

(22) Filed: Feb. 23, 2001

(51) Int. Cl. G06F 17/60

(52) U.S. Cl. 705/11; 705/7; 705/9

(57) ABSTRACT

A production system interface for the flexographic platemaking industry includes a customer interface and an order and job processing application. A database is maintained including customer and job specification data for a plurality of job orders for plates. The status of each job order is tracked by the system and maintained in the database via a status indicator. The system provides for quality control checklists before a job order may be routed to the next responsible employee or department in the manufacturing process for action. Customers may access the database through the Internet to track their job orders. Employee time and material usage may also be tracked and stored in the database for use in invoicing the job order when the manufacturing process has been completed.

### FIELD OF THE INVENTION

The present invention relates to project management systems, and more specifically to a project management systems and customer interfaces to such systems in the flexographic platemaking industry.

### BACKGROUND OF THE INVENTION

Flexography is a process of rotary letterpress printing using flexible plates and fast-drying inks, typically water-based inks. This printing method is especially utilized for printing on plastics, papers and cardboard. Particular industries that makes great use of this process are the box manufacturing industry, particularly the cardboard box packaging industry, and the cardboard display manufacturing industry. Most cardboard boxes used to package products (e.g., beer, candy, computers, etc . . . ) include some form of printed design. The design is typically printed on a planar foldable box profile using the flexography process. Each individual design is printed from a unique flexible plate or plurality of plates. These plates are commonly formed from a rubber or photopolymer material by a company that specializes in manufacturing the plates (herein referred to as a “platemaker”).

The platemaker, through its sales representatives, receives an job order for a plate used to print a design directly from the manufacturer of the product to be packaged, from a buyer representing the manufacturer, or from a converter that supplies the boxes to the manufacturer. In any case, the platemaker then undertakes the task of converting the design into a flexible plate or series of plates that may be utilized in the flexography process by the converter.

Generally, once an order is received by a sales representative, a hard copy paper order form is completed. The order form includes the customer information and job specifications. An electronic version of the job design is then created either from a sample provided by a customer or from an electronic file provided by the customer. The artwork is checked several times against the customer's specifications and design. A life size negative of the artwork is generated, and the negative is checked against a blue-line copy of the design. The negative may also be used to bum a color version of the design on a color sensitive material for approval by the customer.

Once the design is verified and approved, the negative is used to create either a rubber plate in a vulcanizing process or a photopolymer plate in a masking process. The dimensions and thickness of the resulting plate(s) are then verified and approved, and the plate is mounted on a carrier sheet if specified by the customer. A rubber protective layer for the plate may also be engraved or cut at this point.

After the plate is mounted, the mounted plate is checked against the mounting specifications. If approved, a print card or 8.5×11 miniature color version the foldable box profile with the design that may be created from the plate(s) is generated. The plate is then prepared for shipping, and an invoice is generated.

While the above described steps (i.e., intake, art development, plate manufacturing, shipping, invoicing, etc . . . ) are, generally speaking, standard in the platemaking industry, the industry has primarily relied upon hard copy paperwork to identify and track customer orders through the process. This reliance on hard copy orders presents several problems in this industry. For example, employee time is wasted because inquiries pertaining to specific jobs must be directed to the person(s) having physical possession of the job order paperwork, to customer representatives, or to supervisors. The progress and status of the job must also be tracked through the paperwork. Data contained in hard copy form is inherently not searchable without elaborate cross-referencing systems, and supervisors cannot generate daily or weekly work status reports without first referencing individual work orders or logs generated from the work orders. The hard copy paper system also does not incorporate quality control features with tracking of the status of the job order through the manufacturing process. It should be apparent that this inefficient reliance on paperwork can lead to significant problems in an industry that is very deadline sensitive, i.e., products can not be shipped without boxes, boxes cannot be provided without their designs, and the designs cannot be printed without the flexographic plates.

Still further, customers (including manufacturers, buyers and converters) currently cannot track their orders or obtain comprehensive or selective order histories without contacting a representatives of the platemaker, typically by telephone, facsimile, or other conventional means. This in turn places additional demands on the already limited time of the platemaker's employees. The contacted representative must also obtain the information from hard copy files and communications with other employees responsible for the individual stages in the above described flexographic platemaking process. Further, this inability of the customers to directly access the records of the platemaker forces the customer to maintain a detailed and archived system of past and present orders.

Therefore, there remains a need for a more complete and user friendly system and method for tracking and managing job orders through the entire flexographic platemaking process. There also remains a need for a system which provides improved organization, search and quality control capabilities and which provides the synergistic benefits associated with a centralized and comprehensive system. Still further, there remains a need for a system which improves customer access to job status and job history information.

### SUMMARY OF THE INVENTION

The present invention is a method and system for processing and managing a plurality of job orders for a plurality of flexographic plates being manufactured via a flexographic plate manufacturing process where the flexographic plate manufacturing process includes a plurality of stages, each stage of the plurality of stages being characterized by at least one quality control requirement that is verified by at least one employee entity. Job specification and customer data are stored for each of the plurality of job orders in a database. A status indicator for each of the plurality of job orders is also stored in the database. The status indicator identifies a stage from the plurality of stages in which each of the plurality of job orders respectively is pending. Confirmation is received pertaining to a selected job order that the at least one quality control requirement has been verified for at least one of the stages of the manufacturing process. The status indicator is updated for the selected job order to indicate the employee entity identified in the routing command.

In another embodiment of the present invention, customer data and job specification data for a plurality of job orders are stored in a database. A status indicator for each of the job orders is maintained to identify a stage of the flexographic manufacturing process in which each of the job orders is pending. Access is provided, through a computer network to at least one customer that uses a customer terminal, to at least a portion of the customer and job specification data and to the status indicator for job orders associated with the customer.

The present invention provides several benefits over prior paper systems. Customer and job specification data are easily accessed by both customers and employees. A database containing the data is searchable, and the status of a job order is readily obtainable. Further, quality control measures are implemented along with job tracking. The system may also be configured to track employee time and material usage and combine this functionality with invoicing features. Still further, the search capacities simplify the generation of status reports and eliminate many time consuming inquiries to sales representative and supervisors.

The above and other features of the present invention will be better understood from the following detailed description of the preferred embodiments of the invention that is provided in connection with the accompanying drawings.

### BRIEF DESCRIPTION OF THE DRAWINGS

FIG. 1 is an illustration of an exemplary embodiment of a combined order and job processing and customer interface system of the present invention;

FIG. 2 is block diagram illustrating the components of an exemplary production system interface;

FIG. 3 is a block diagram illustrating the component modules of an exemplary order and job processing application;

FIG. 4 is a flow chart illustrating the function of an exemplary job entry module;

FIG. 5 is a block diagram illustrating the individual modules of an exemplary job processing module;

FIG. 6 is a flow chart illustrating the function of an exemplary art department module;

FIG. 7 is an illustration of an exemplary art department interface screen;

FIG. 8 is a flow chart illustrating the function of an exemplary art director module;

FIG. 9 is a flow chart illustrating the function of an exemplary production coordinator module;

FIG. 10 is a flow chart illustrating the function of an exemplary camera department module;

FIG. 11 is a flow chart illustrating potential work flow through a platemaking process;

FIG. 12 is a flow chart illustrating the function of an exemplary status reports module;

FIG. 13 is a flow chart illustrating the function of an exemplary customer database search module; and

FIG. 14 is a flow chart illustrating the function of an exemplary customer interface module.

### DETAILED DESCRIPTION OF THE PREFERRED EMBODIMENTS

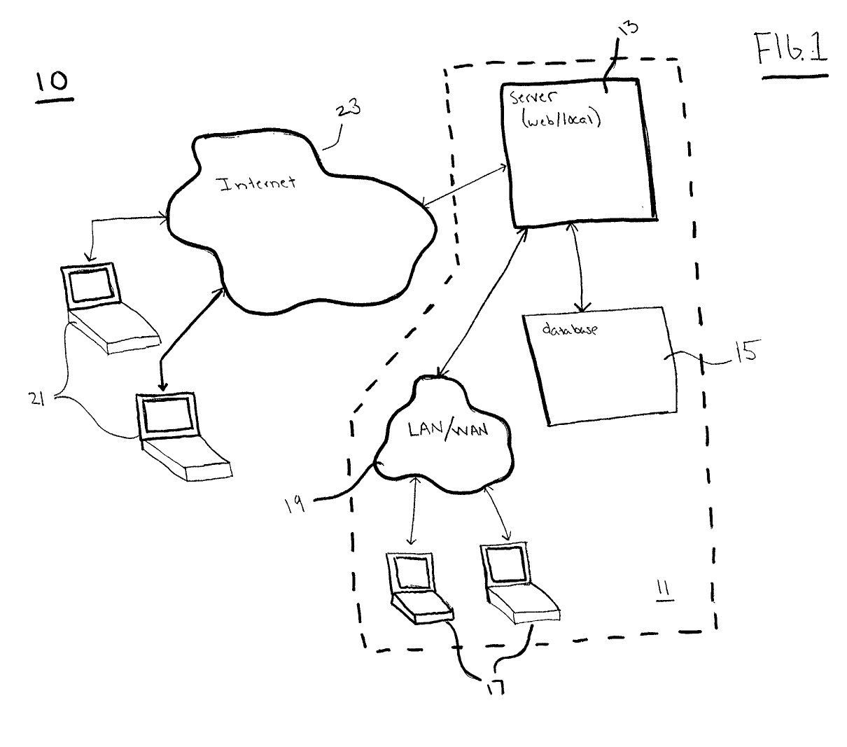

FIG. 1 is a block diagram of an exemplary combined project and process management and customer access interface system 10 for the flexographic platemaking industry. Shadow box 11 indicates certain components of the communication hardware of the flexographic platemaker.

A server 13 of conventional design may be programmed with code to execute the process steps of the exemplary embodiments of the present invention. Specifically, the server 13 may be programmed with an order and job processing application which provides for job order entry, tracking and management, and a customer interface module for providing remote customer access to customer information stored in a database 15 connected to server 13. Employee terminals, such as computers 17, are preferably connected to server 13 and, therefore, to database 15, through local or wide area network 19.

Customer terminals, such as computers 21, may connect to server 13 through a computer network 23, such as the Internet. Customer terminals 21 may connect to the Internet through a telephone line and local Internet service provider, through a dedicated line, as is common with many businesses, through a local or wide area network, through a broadband connection, or the like. The customer terminal can also connect to the Internet using wireless technology, such as hand held units communicating through the Internet via the wireless access protocol (WAP). A computer 21 generally accesses a server 13 functioning as a web server by entering the domain name of the server 13 in an Internet browser software program, such as NETSCAPE or Microsoft's INTERNET EXPLORER. The customer terminal 21 may also be a pager which can communicate through the Internet using the Internet Protocol, a Kiosk with Internet access, a connected electronic planner (e.g., a PALM device manufactured by Palm, Inc.) or other device capable of interactive Internet communication, such as an electronic personal planner, or combination thereof.

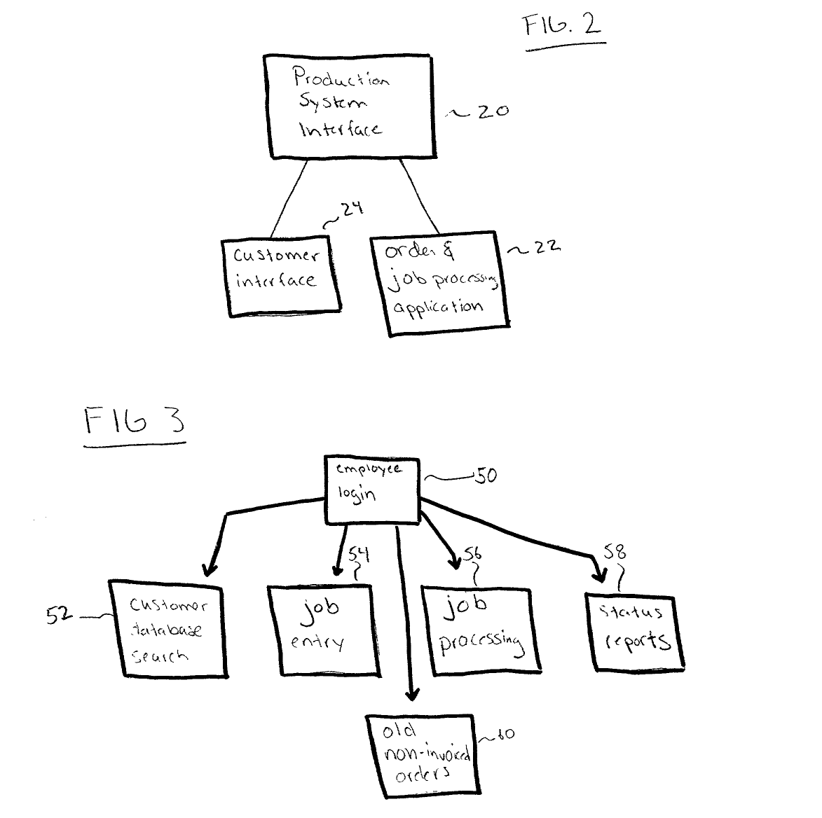

The functionality of the programmed server 13 is described hereafter in connection with the flexographic platemaking process. A production system interface program 20 of the present invention may be stored on server 13 and preferably comprises two functional components as shown in FIG. 2. An order and job processing application 22 provides for job order entry, tracking and management and interfaces with the database 15. The customer interface module 24 provides customer access to selected order-related data in the database 15. The order and job processing application 22 is first described hereafter.

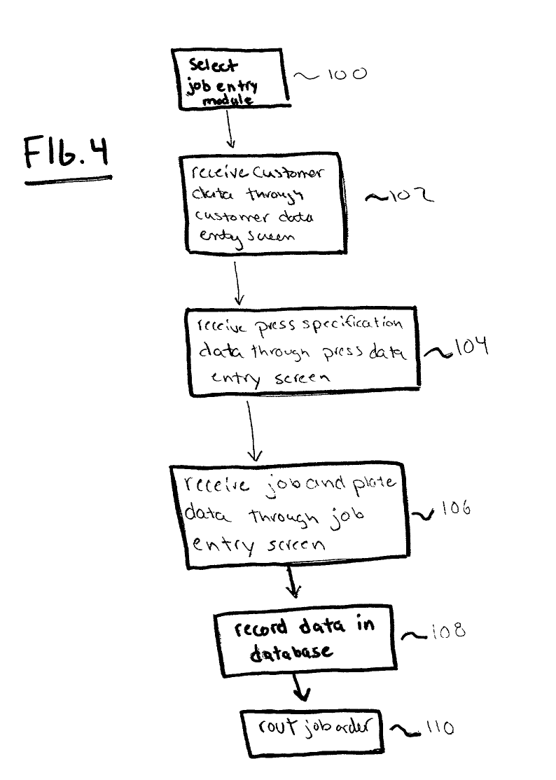

The order and job processing application 22 preferably first presents the user, i.e., an employee of the platemaker, with a login option generated by a login module 50 as shown in FIG. 3. The employee preferably enters a username and password and is then granted access to the options presented by the individual modules shown in FIG. 3: the customer database search module 52; the job entry module 54; the job processing module 56; the status reports module 58; and the old non-invoiced module 60. It should be understood that the modules described herein are merely illustrative of the functions of an exemplary order and job processing application 22 and may be organized, combined and programmed in a plurality of different manners.

In the preferred embodiment, the modules of an exemplary production system interface 20 are programmed to interface with a user (e.g., an employee using a employee terminal 17 or a customer using a customer terminal 21) in a windows based environment that allows easy data entry, option selection, and data display, such as through data entry windows and pull down windows. In this manner, each data entry window of a screen generated by a module and displayed to the user on a monitor connected to a terminal 17, 21 may be considered a prompt or request to the user to take some action or make a selection and a means of receiving data from the user. By configuring these windows (e.g., entering information or selecting an item from a pull down window), the user submits data to the module which the module may then manipulate, store, and/ or use to generate an output according to its programming. Such an interface may be programmed by one of ordinary skill in a plurality of programming languages and/or with a plurality of different programs. One exemplary programming system is FILEMAKER PRO programming system which allows a generic program to be reconfigured into a windows based interactive application having specific programmed functionality. Further, results of requests for data (e.g., a search request, status check, etc . . . ) are preferably displayed to a user on a monitor connected to a user terminal 17, 21, but the data may also be downloaded to a storage medium (e.g., a diskette), outputted to a printer, or outputted to another conventional output device or devices.

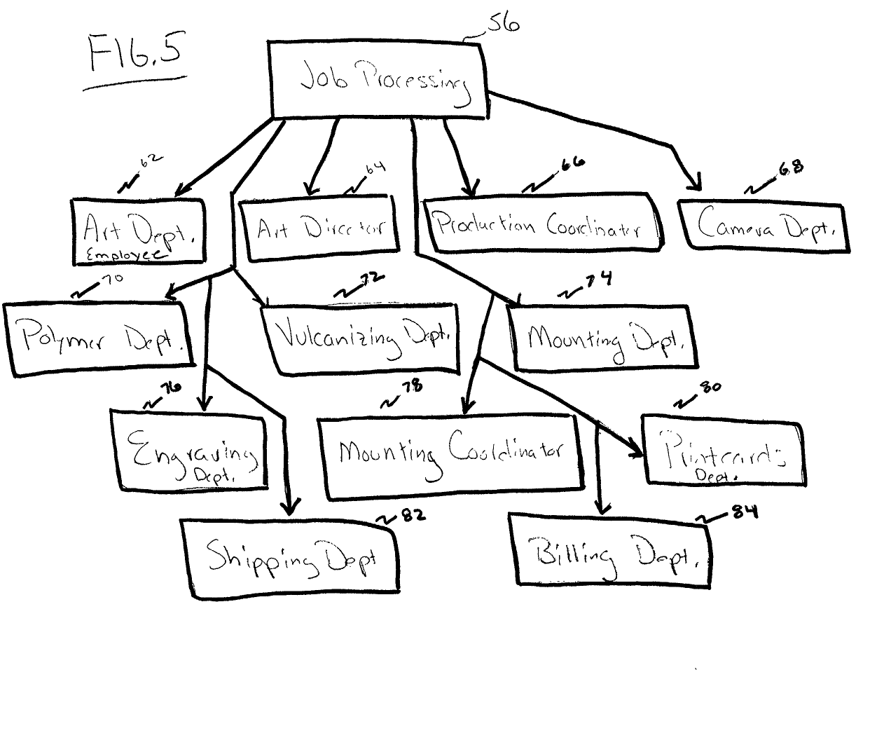

Once an employee of the platemaker, such as a sales representative, receives a job order for a plate or series of plates for creating a customer design, the job order is entered into the production system interface 20 using the job entry module 54. The job entry module 54 functions as a window into the database 15 for recording the specifications of the job order and customer data. As shown in FIG. 4, once the module 54 is selected at step 100, the module 54 preferably presents the employee with a windows based customer data entry screen. In this data entry screen, customer information is entered for the first time (as with a new customer), retrieved from the database 15 (as with an existing customer) or retrieved from the database 15 and modified (as with an existing customer with supplemented or changed information).

Customer data entered into the customer data entry screen 100 and received by the job entry module 54 may include some or all of the following information: customer number, company name, company address or addresses, telephone and facsimile numbers, company email address and domain name of the company's website, shipping address for the finished plate, the pre-negotiated pricing level for the customer and the terms of the pricing agreement (e.g., any discounts or payment schedule terms), Federal Express and airmail preferences and account numbers, general notes of interest pertaining to the customer, and contact information (e.g., names and email addresses) for employees of the customer.

After the customer data is received by the job entry module 54 through a customer data entry screen at step 102, the job entry module 54 preferably displays at step 104 a press specification data entry screen for receiving specification data for the press for which the ordered plate is intended to be used. The screen preferably includes a plurality of entry windows for entering the press specifications. This information may also be retrieved from the database 15 if previously entered in connection with another job order for the customer. These specification should be familiar to those of ordinary skill in the flexographic platemaking industry and include, for example, whether the press includes hanging grommets, the type of press, the cylinder repeat distance (cylinder circumference), the under cut distance (plate thickness plus mounting material thickness), the number of colors that may be printed by the press, the left to right maximum printing range, the amount of mounting material to be cut off around the cylinder, the distance between the lead edge and where the printing begins, the mount center mark location (if any), the minimum line weight that the press requires to print, the normal color trap, the normal bleed top to bottom over knife, the normal bleed left to right over knife, the normal bleed over score, whether the press requires pull bends, and the bend position. The employee is also prompted by the press specification entry screen to enter the mount configurations for plates of different thicknesses. Each mount configuration may include plate thickness, liner type and thickness, lead edge type, trail edge type, and distortion factor.

The job entry module 54 then preferably displays a job and plate data entry screen at step 106 for entry of specific information pertaining to the ordered plate(s) and the design. At this point, the job entry module 54 assigns a job order number to the job order. The job and plate entry data may include such information as the pre-production proof delivery date, and revision date deadlines, the type of proof required (e.g., PDF file, Canon copies, blue-lines, etc . . . ), the plate delivery date and delivery method (e.g., Federal Express), the required box certification mark indicating the qualifying load of the box, the plate type, material, and thickness, the lines per inch of screen required, how many bar codes are required in the design, whether the job requires printcards and in what colors, whether the job requires mounting, whether the customer requires a plot of the design and on what material (e.g., paper, vinyl, customer supplied vinyl or paper, etc . . . ), whether the design was supplied by a customer and in what medium (e.g., floppy disk, paper), whether the design was supplied in a CAD format and how it was supplied (e.g., via email), the file name of the design if supplied in electronic format, any additional notes relevant to the job order, and any project, item descriptions, form or product numbers used by the customer for the job.

After the employee has entered the requested customer, press, job and plate information, this data is recorded or stored in database 15 at step 108 for retrieval and use by other modules. The employee is also prompted to rout the job order at step 110 after confirming that the employee has entered all of the required customer and job information and performed all tasks required of the employee. The job entry module 54 preferably generates a checklist for the sales representative or other employee entering the data. The job entry module 54 should require that the employee complete the checklist and initial it before routing the job order. The checklist may be generated on a computer monitor in the windows environment and checked using a pointer, such as a mouse. The checklist may, for example, require that the employee confirm that the delivery date for the order was entered correctly, that the cylinder size and type of press were entered correctly, that any added notes or instructions are clear, that existing customer samples were reviewed, that the print layout was noted, whether printcards are or are not required and in what colors, that selected mounting specifications were included, that customer contacts were noted, and that any certification or recycling stamps were noted. The checklist may always list the same items regardless of whether the item was entered by the employee in order to make the employee double check his or her work, or the checklist can list only required information that was not entered by the employee. Of course, the employee need not enter all of the information in one session, but rather may store any information entered into the database 15 and later retrieve the information for completion.

If the employee has not confirmed that all of the required information and tasks have been completed, the job entry module 54 preferably does not allow the employee to release or rout the job. If the checklist is completed and initialed, a pull down window on the data entry screen may provide the employee with a list of different departments or employees to release or to rout the job order to for further action. The list is preferably comprehensive so that the employee can choose to rout the job order to a number of different employees or departments, but the list may be restricted depending upon from which stage of the manufacturing process the job order is being routed. For example, if a platemaker dictates that the job order always be routed to an art department employee after completion of the data entry stage, the job entry module 54 may be configured to limit the employee's choices of departments or persons to whom the job order may be routed.

By “releasing” or “routing” of the job order, it is meant that a status indicator stored in the the database 15 and associated with the specific job order is set to the employee, department, or manufacturing stage indicated by the selected routing destination. Once a job is released or routed, it may be assumed that the manufacturing job identified by the job order has progressed to a new stage of the plate manufacturing process for action by a different employee or department (or the same employee acting in a different employment capacity). The status indicator, therefore, preferably indicates which employee or department currently has responsibilities or tasks to complete for the ordered job and, therefore, in which stage of the manufacturing process the job order resides. “Routing” or “releasing” does not imply that the system 20 or modules of the system 20 physically move the project in any way because physical activity, e.g., printing, plate engraving, etc . . . , is accomplished by the employees, but not by the modules of the system 20.

The job entry module 54 greatly simplifies the record keeping of customer and job data when compared with paper hard copy systems. The customer data and job specification information are entered in an efficient and user friendly manner and are then stored in database 15. The data may be organized in any acceptable manner in the database 15 for retrieval and updating. The job data is also made available to the job processing module 56, which is described below. Further, the job entry module 54 requires confirmation that all of the data entry tasks have been completed and/or completed correctly before permitting the job order to be routed for action by another employee or department.

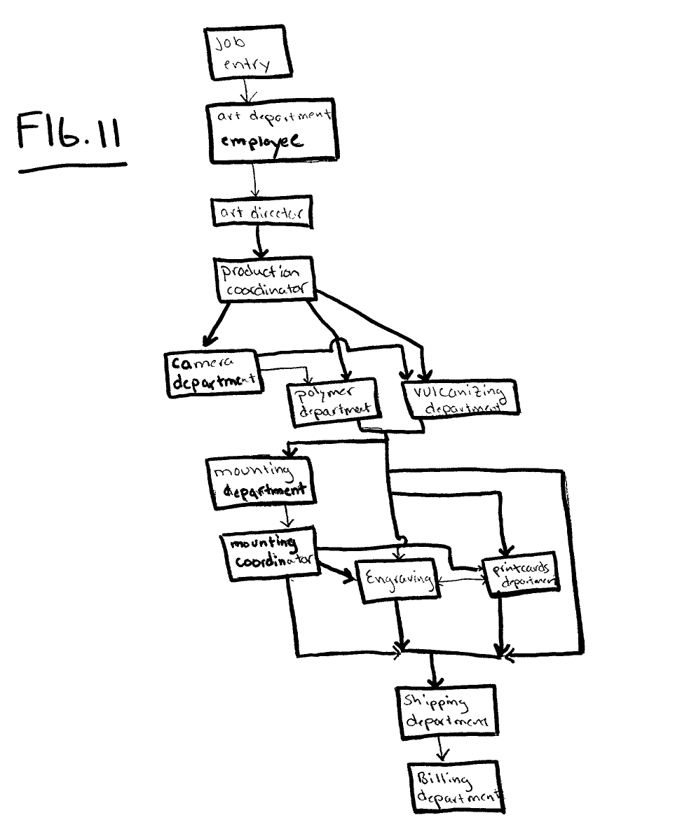

Once the customer and job data are entered via the job entry module 54, the steps described generally in the “Background of the Invention” section are performed by the flexographic platemakers in order to transform the design of the customer into a finished plate that may be shipped to the converter. It should be understood that these steps may vary from platemaker to platemaker, as may departmental and employee duties, but the basic functionality of the job processing module 56 may be utilized by a platemaker through its employees to more efficiently execute these steps as described hereafter. FIG. 11 illustrates on possible work flow path for a plate manufacturing job, and therefore a job order, through a platemaker that utilizes the employees and departments described below.

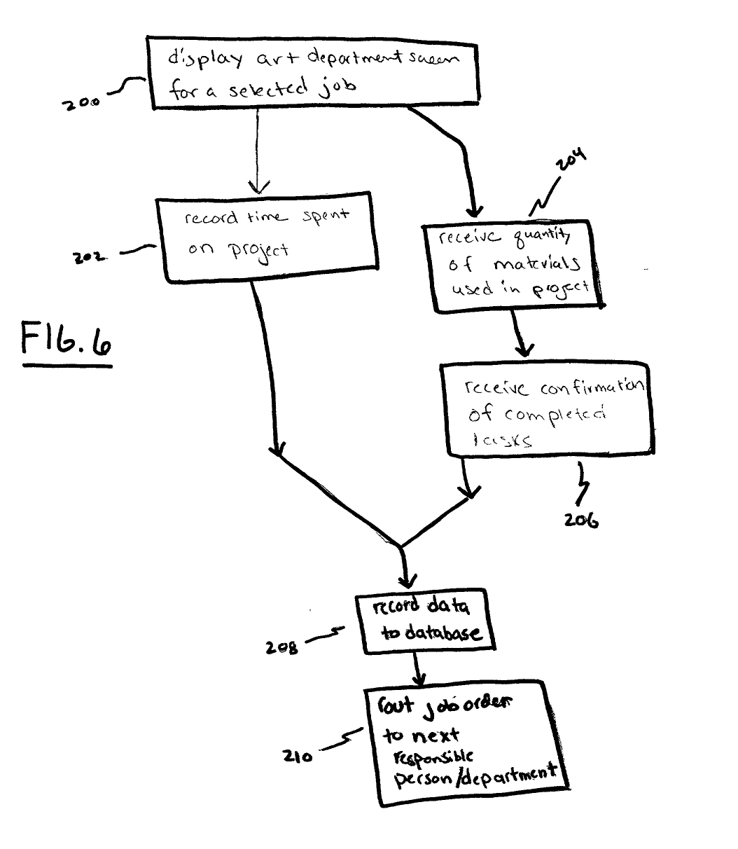

An exemplary job processing module 56 preferably includes a plurality of modules which generate a plurality of employee interfaces each customized for individual persons or departments having responsibilities for specific tasks in the flexographic platemaking process. For example, an exemplary job processing module 56 may include the modules 62-84 shown in FIG. 5 individualized to the job responsibilities of an art department employee, the art director, the production coordinator, the camera department, the polymer department, the vulcanizing department, the mounting department, the engraving department, the mounting coordinator, the printcard maker, the shipping department, and the billing department. As described hereafter, the employee interfaces generated by the individual modules of the job processing module 56 allow employees to track time spent on specific projects and materials used, track the status of a project (i.e., in which stage of the manufacturing process is an individual project located), and require verification of completion of responsibilities of individual employees before routing the job order to the next responsible employee or department to begin work on the project. The employees are prompted by the interfaces generated by the modules, and any entered information is recorded in the database 15. The modules share information to prevent duplicative entry of data and to provide a synergistic summing of the functions of the individual modules.

Once a job order is received by a platemaker, an art director typically delegates to an art department employee the responsibility of preparing an electronic design that meets the customer's specifications and that can be converted into a life size negative. This task is generally accomplished using conventional graphic software packages. When a flexographic platemaker employs the system of the present invention, the art department employee assigned the project by the art director can access the art department employee module 62 of the job processing module 56 and identify whether the project has been routed to the art department, i.e., whether the status of the job order stored in the database 15 indicates that the job order is presently pending in the art department. If the job has not been released or routed as described in connection with the job entry module 54, the art department employee knows that his or her responsibilities for the project have not yet vested because some or all of the tasks required of the employee that enters the job into the system (specifically database 15) through job entry module 54 have not been completed. Alternatively, the job order may have been routed to another department or employee of action before any work by the art department employee is to commence. The art department employee may identify such a department simply be requesting the status indicator or the job order stored in the database 15 from the art department employee module 62.

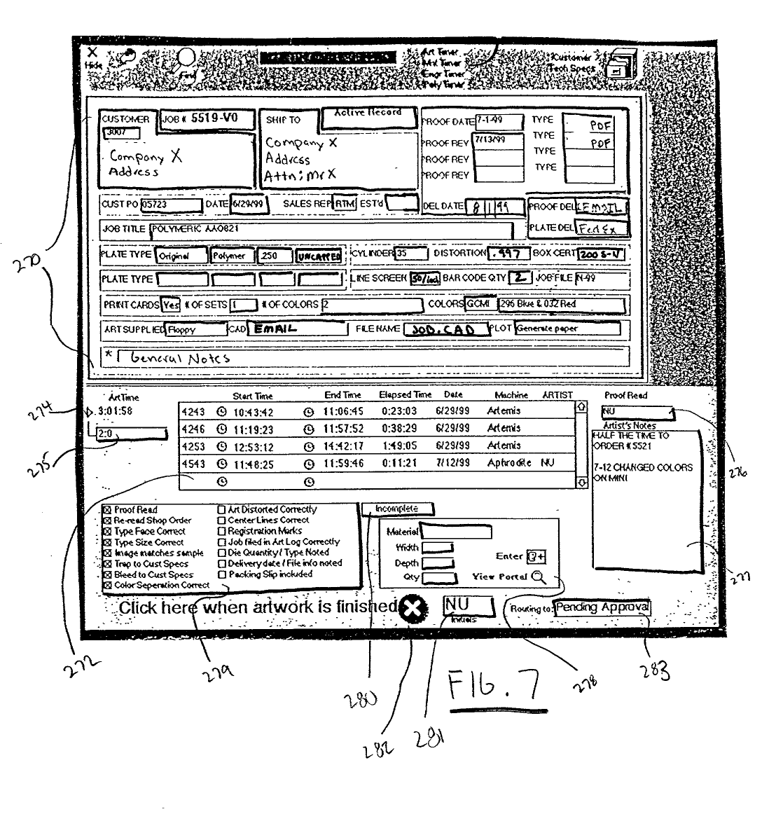

FIG. 6 illustrates the function of an exemplary art department employee module 62. The art department employee may select the art department employee module 62 of the job processing module 56 using a user terminal 17. The employee preferably enters a job number, and an art department screen for the selected job order is displayed to the employee at step 200. The art department employee may access the job report even if it has not yet been routed to the art department pr the art department employee in order to obtain information regarding the job order or to confirm partial completion of her responsibility for the job if some or all of the art department employee's responsibilities may be accomplished while other employees simultaneously work on the project. The art department employee module 62 allows the employee to track her progress on the individual project as well as her time through the interface screen. A portion of the displayed screen preferably contains much for the information entered in the job entry module 54 for the employee's convenience (e.g., a displayed “job ticket”) as described below in connection with FIG. 7.

The art department employee module 62 records the time spent by the employee on the individual project at step 202, preferably through an electronic timer displayed on the art department screen. Therefore, the employee should access the art department employee module 62 any time she works on the individual project. The electronic timer is preferably a software application that records the total time spent on an individual project, the start and finish times, the employee terminal 21 used by the employee, as well as the person that worked on the project. All of the time previously spent by art department employees on the project and/or other departments may also be displayed. The recordation of time feature of the art department employee module 62 allows for easy invoicing and billing of employee time when a job order is completed as well as simplifies managerial analysis of employee efficiency.

The art department employee may also enter notes relevant to the specific job in a window, such as a note identifying how the employee's time was spent. This feature may also be incorporated into the timer feature. The materials and quantities of materials used by the artist, such as negative paper or other material, and blue-line materials, may also be entered by the artist into a materials data entry window at step 204. This feature is particularly helpful when a final invoice is generated because customers are generally billed for materials by the square inch of material used in the job order.

The art department employee module 62 also preferably presents the employee with a quality control check list like that describe above in connection with the job entry module 54, only directed to tasks required of an art department employee. The art department employee can “check” at step 206 the individual tasks that she is responsible for completing when the individual tasks are completed by her. The art department employee module 62 preferably does not allow the art department employee to “release” or “rout” the project to the next responsible employee until all of the required tasks are checked as “completed” and the employee has initialed (e.g., by typing her initials) her work in the art department screen. The checklist may include, for example, confirmation that the design (including any wording) was proofread, that the shop order was re-read, that the type face is correct, that the type size is correct, that the image matches any samples provided, that the trap matches the customer's specifications, that the bleed matches customer specifications, that the color separation is correct, that the distortion factor is accounted for correctly, that any center lines are correct, that any federal or state registration or any certification marks are included in the design, that the job was filed in the art log correctly, that the die quantity and type were noted on the displayed job ticket, that the delivery data and file info were noted on the displayed job ticket, and that a packing slip is included with any proofs to be sent to the customer for approval.

Once each of the tasks listed by the art department employee module 62 has been checked as being completed, the art department employee should initial her work and rout the job order to the next responsible party. The employee may rout the job order by, for example, selecting or clicking on a routing button displayed by the art department employee module at step 210 and by selecting the routing destination employee or department (collectively “employee entity”) from a pull down window. As described in connection with the job entry module 54, “routing” means that the artist's responsibilities for the project are completed and verified, at least for the time being, and any work completed by the artist can be used by the next person(s) having responsibilities in the flexographic platemaking process. In essence, the job has progressed to the next stage in the flexographic plate manufacturing process. The status indicator associated with the job order in the database 15 is updated any time the job order is routed to indicate the the routing destination.

The time and materials data are saved to the database 15 at step 208, as well as any other information entered by the art employee (e.g., the tasks completed by the employee and her initials and any changes to customer or job data). Typically, the art department employee should rout the job order to the art director for approval at step 210. In essence, the art director is then required to verify that he has completed his responsibilities for the individual project using the job processing module 56, and specifically the art director module 64.

FIG. 7 is provided as illustrative of an exemplary screen displayed to the art department employee by the art department employee module. The upper portion of the screen 270 includes what may be considered a “job ticket.” The job ticket for the employees convenience includes much of the information entered through the job entry module 54. Below the job ticket, window 272 displays the time that has been spent on the project and the dates, which employee terminal was used to log the time, and which artist logged the time (if the artist did not use his/her assigned employee terminal). Window 274 indicates the total time that has been spent by all art department employees on the ordered job. Window 275 allows this time to be changed (either higher or lower as necessary) before invoicing. Window 276 identifies the initials of the person who performed the proofing task(s), and window 277 indicates any additional notes for the job added by the art department employees. The types of materials and material quantities used may be entered in window 278.

Window 279 includes a checklist of the art department employee's responsibilities. Only approximately half of the tasks have been checked, so window 280 indicates “incomplete” rather than “done.” Window 281 indicates the initials of the employee(s) who routs the job order, and, therefore, who implicitly verifies the accuracy of a checked checklist shown in window 279. Routing window 283 may be used to select the routing destination when routing button 282 is selected. The routing destination window 283 may also be set to other status indicators while the job order is pending before an employee entity (i.e., is pending before an employee or within a department) in order to indicate a substatus for the job order. This substatus may also be stored as an indicator in database 15. For example, “pending approval” may indicate that the job order is still pending before the art department employee (as indicated by the status order), but that proofs generated by the art department employee are with the customer for approval.

It should be understood that the screens of FIG. 7 generated by the art department employee module 62 of the present invention is only an example of a possible screen format. Other formats may be presented to the employee while still providing the exemplary functionality of a art department employee module 62 according to the present invention. Other screens presented to employees by the modules of the job processing module 56 are preferably provide similar options, but customized to the individual employee's or department's responsibilities, and a job ticket.

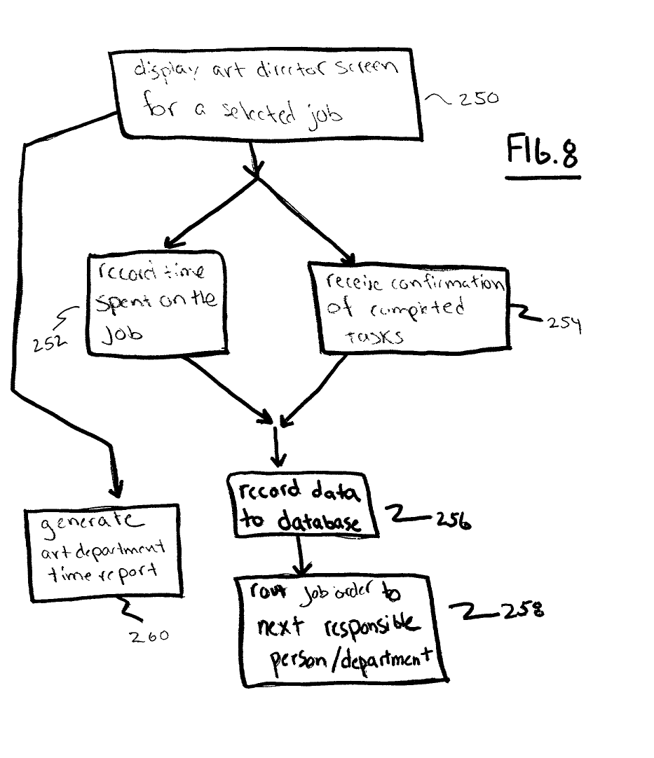

The art director preferably accesses the system 20 by selecting the job processing module 56 and entering a job number. The art director module 64 of the job processing module 56 displays at step 250 (FIG. 8) an art director screen specific to the selected job order and the art director's responsibilities in connection with that job order. Again, the job ticket containing general information for the job (shown in FIG. 7) may be displayed on the screen. As described above in connection with the art department employee module 62, the art director may enter and record his time spent on the job at step 252 using an electronic running clock. The total time spent by the art department and by whom is also preferably displayed to the art director. A check list of tasks required of the art director is displayed to the art director. The art director can confirm completion of the tasks as described above by “checking” at step 254 each listed task when completed. These tasks may include verifying the information confirmed by the art department employee and verifying completion of the job to the proper specifications. Once all of the checkboxes displayed by the art director module 64 have been checked, the art director may enter his initials to confirm completion of the tasks and release the project to the next responsible party. The time and confirmation data are recorded in database 15 at step 258, and the status indicator is updated when the job order is routed to the next responsible party at step 258.

The art director module 64 through the art director screen also preferably provides the art director the option of generating an art department time report at step 260. The generated art director is preferably provided the option of customizing the time report by job, dates, employees, or combination thereof. The generated report preferably includes a listing of art time entries stored in the database 15. Individual elements in the list may include the employee entering the time, the date the time was spent on the job, the elapsed time spent, the initials of the employee (if entered) and any final revised time entered for the job as described above

The job order may be routed to the production coordinator from the art director for another review of the work of the art department. Once the job becomes the responsibility of the production coordinator (i.e., the job has been released by the art director using the art director module 64), the production coordinator may select the job production coordinator module 66 of the job processing module 56 and gain access to an art director screen by entering the job number.

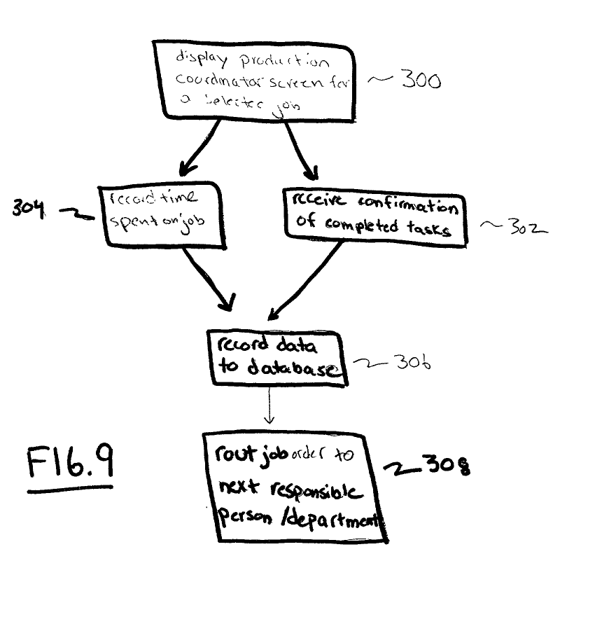

FIG. 9 illustrates the function of an exemplary production coordinator module. As described in connection with the art department employee module 62 and art director module 64, a production coordinator screen is displayed by the production coordinator module 66 at step 300 on a monitor connected to user terminal 17. The screen displays information pertinent to the job as described above (i.e. the job ticket), but the displayed task checklist is specific to the tasks that are to be completed to by the production coordinator. The production coordinator may verify completion of his tasks (e.g., proofreading and verifying that the job was completed to the proper specifications) by checking the individual task at step 302. If the platemaker charges the customer for the production coordinator's time or if the platemaker chooses to track the production to coordinator's time, the production coordinator module 66 may be configured to record the time of the production coordinator at step 304. The confirmation of the completion of the production coordinator's tasks and any time recorded are stored to the database 15 at step 306. When selected by the production coordinator, the job is routed to the next department or person designated by the production coordinator at step 308. The next responsible person or department in the flexographic plate manufacturing process may be, for example, either the camera department, the photopolymer department or the vulcanizing department.

At this point in the flexographic plate manufacturing process, the electronic art is converted into a life size negative which may be used to produce a color print of the design and/or serve as a mask in creating the plate(s) required for the design. The negative may be checked in a blue-line process, if required by the job order, typically by the polymer department.

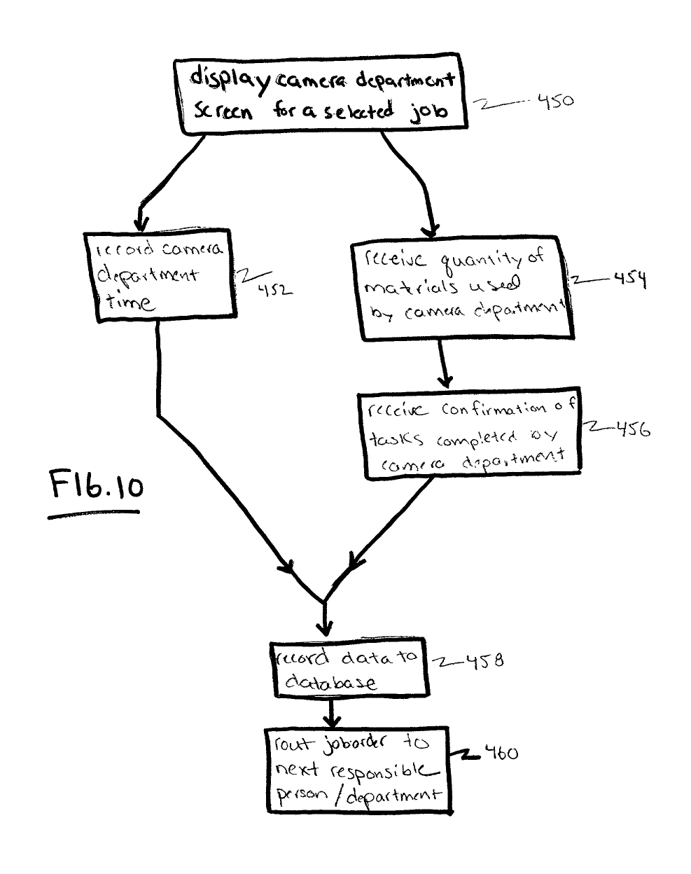

If the job order is routed to the camera department by the production coordinator module 66 at step 308, then the job order and job ticket indicates that the customer wishes to proof a full size color photograph of the design. The camera department module 68 generates and displays a camera department screen to the camera department employee at step 450 of FIG. 10 when the camera department employee selects the camera department module 68 and enters a job number or other identifying indicia for the job (e.g., job name). Assuming the job has been routed by the production coordinator to the camera department, the screen includes a job ticket for the job and a quality control checklist specific to the responsibilities of the camera department. The camera department module 68 may be configured to record the time of any camera department employee working on the job order at step 452 and any materials used by those employees at step 454, assuming that the platemaker bills for this time and material. Of course, the platemaker may choose to charge flat fees for this service or incorporate the fee in other billable items.

The camera department module 68 is also preferably configured to receive confirmation at step 456 from the camera department employee that all of the tasks required of the camera department have been completed. This feature is preferably incorporated as a list of tasks and accompanying checkboxes as shown in FIG. 7 in connection with the art department screen generated by the art department modules 62. These tasks may include, for example, confirming the density of the print, confirming that the negative trim is correct with the centers, that the die quantity and type are correct, that the delivery date is correct as well as general file information on the negatives, that the centers are scribed on the customer's negatives, and that the negative's emulsion is up. Once these tasks have been completed, any data (e.g., time, material, and confirmation data) entered by the camera department employee is stored to the database 15 at step 458 and the project is routed at step 460 to the next responsible person or department designated by the camera department employee with the camera department module 62—typically either the polymer or vulcanizing department.

The job order may be routed to the polymer department by either the camera department or the production coordinator. The polymer department employees access the polymer department module 70 of the job processing module 56. Much as described above in connection with the art department employee module 62, the art director module 64, the production coordinator module 66 and the camera department module 68, the polymer department module 70 preferably allows the polymer department employees to record their time spent on individual projects, record quantities and types of materials used, confirm that all required tasks have been completed, record the aforementioned information to the database 15, and route the job order to the next responsible person or department after confirmation of completing all required tasks. The next responsible person or department may be, for example, either the mounting department, the engraving department, the printcards department or the shipping department, as required by the specific job order and preferably indicated by data on the job ticket. A list of tasks presented to a polymer department employee by the polymer department module 70 may include confirmation of the following: that the negative trim is correct with the centers, that the plates meet caliper and relief standards, that the reverse images are open, that the plates have adequate shoulders, that the resin type and cap are verified, that the plate surface is clean and the trim is correct, that the rubber master meets height and relief specifications, that the master has no undercuts, that the master is clean, and that the delivery data and quantity are marked on the master.

Similarly, if the job is routed to the vulcanizing department from either the camera department or the production coordinator, the employees of the vulcanizing department may access the vulcanizing department module 72 of the job processing module 56. Much as described above in connection with the art department employee module 62, the art director module 64, the production coordinator module 66, the camera department module 68, and the polymer department module 70, the vulcanizing department module 72 preferably allows the vulcanizing department employees to record their time spent on individual projects, record quantities and types of materials used, confirm that all required tasks have been completed, record the aforementioned information to the database 15, and route the job order after confirmation of completing all required tasks to either the mounting department, the engraving department, the printcards department or the shipping department, as required by the specific job order. A list of tasks presented to a vulcanizing department employee by an exemplary vulcanizing department module 72 may include confirming the following: that the mold image is clean, that the die quantity and delivery date are marked on the mold, that the plate meets proper micrometer height, that the ordered quantity is verified, and that the die's surface is clean.

The job order may be routed to the mounting department from either the polymer or vulcanizing departments if the original job specifications of the job order indicate that the customer requested a mounted plate. An employee in the mounting department accesses the mounting department module 74. The mounting department module 74 may be configured to record mounting department employee time and material usage as well as task completion confirmation information. This information may be recorded to the database 15, and the mounting department module 74 may be configured to route the job order to the mounting coordinator when it is confirmed that all required mounting tasks have been completed. Some possible mounting tasks requiring confirmation of completion on a mounting screen generated by the mounting department module 74 include confirming that the mounting specifications and scoring are correct, that the mounting aligns with the proper cylinder size, that the proper mounting substrate is utilized, that the mounting material meets customer specifications, that the proper lock is used, that hanging grommets are included if required, that pull bends are included, that registration marks are included, that certification stamps are included, that the plates are positioned properly and sealed properly, that the proof impression is at .010″ maximum, that the proof matches the sample, that the proof type and quantity are correct, and that the shop order has been re-read. Some of the tasks listed by the mounting department module 74 may be retrieved from the mounting specifications entered in the job entry module 54. For example, there is no need for the module 74 to require that the mounting department verify that hanging grommets are included if the job specification does not require hanging grommets. The task list for the mounting department generated by the mounting department module 74 (as well as task lists generated by the other modules of the job processing module 54), therefore, may be dynamically created, at least in part, from information supplied in the job entry module 54. After confirming that the required tasks have been completed by the mounting department, the mounting department employee may release the job order to the mounting coordinator through the mounting department module 74.

The mounting coordinator module 78 preferably displays a mounting coordinator screen specific to the accessed job order and mounting coordinator's responsibilities when accessed by the mounting coordinator. The mounting coordinator module 78 preferably records the mounting coordinator's time if required and presents the mounting coordinator with a confirmation list listing tasks required of the mounting coordinator. Again, this information, when entered, by the mounting coordinator, may be stored in the database 15, and the job order may be released to either the engraving department or shipping department. A possible lists of tasks presented to the mounting coordinator by an exemplary mounting coordinator module 78 for confirmation of completion include reviewing the complete customer order, verifying the placement and content of the design, verifying that the scoring is correct, verifying the view, verifying that the Mylar is keyed in, verifying that the lead edge is correct, verifying that the barcode is scanned, verifying that the C list is complete, generating a packing slip, confirming the creation of a miniature and a customer copy on disk, confirming that the sample proof is returned, confirming that the shipping information is complete, confirming that the design includes certification stamps, and confirming the correct pull bends. The job order may then be released for action by the mounting coordinator module 78 to, for example, either the engraving department, the printcard department or the shipping department as required by the job order. The mounting coordinator module 78 may also be configured to provide a mounting department time report similar to that described above in connection with the art director module 64, only configured to report mounting department time.

The engraving and printcard department modules 76, 80 function much like the other modules of the job processing module 56 described above. They may be configured to record and store employee time and material usage and record and store confirmation of completed tasks. The modules may also be configured to rout the job order to the next responsible department or party for action, e.g., to the shipping department. An example of tasks that may be verified as completed by the engraving department module 76 using a checklist include confirming that the art rub offs and tracing match design created by the art department, that the proper engraver's rubber was selected, that the durometer of rubber meets specifications, and that the cylinder size is verified. An example of tasks to be verified by the printcard module 80 includes confirming that the printcard matches the job layout and verifying that the print copy is clear, that the required customer information is on the card, that the print colors match the job specifications, that the the card stock color is correct, that the quantity is correct, and that the shop order has been re-read.

Once the job order is released to the shipping department, the shipping department employee may access the job order through the shipping department module 82. The shipping department employee's responsibilities include preparing the product (e.g., plates, etc . . . ) for packaging. The shipping department employee, through the shipping department module 82, verifies that any required samples, customer art, printcards, Mylar(s), strike-off proofs, and loose plate(s) are included in the packaging. At least part of checklist may be generated by the shipping department module 82 from the information entered in job entry module 54. The shipping department module 82 also preferably allows the shipping employee to generate a shipping label which includes typical shipping label information, such as shipping destination and shipping method (e.g., via Federal Express or airmail). The shipping label may be printed and attached to the packaging. Once the shipping department employee verifies through the shipping department module 82 that all required shipping tasks have been completed, the shipping department employee preferably routs the job order through the shipping department module 82 for action by the billing department.

After the project is routed for action by the billing department, a billing department employee accesses the job order for invoicing, printing and exporting as described hereafter. The billing department employee may access the job order through the billing department module 84 of the job processing module 56. Again, the job ticket is preferably displayed by the billing department module. Any information stored ind database for the job order may be retrieved and included in a final invoice as desired. The billing department module 84 also preferably itemizes costs in a temporary list for the billing department employee. These costs are generated according to the pricing level negotiated with the customer and entered in the job data entry module 54. The costs may be generated from data stored by the above-described modules in the database 15, such as quantities and types of materials used, time spent by individual departments and employees on the project, and shipping costs. The list of itemized prices may preferably be modified by the billing department employee, such as a billing department manager, to account for lower or higher than expected itemized prices. For example, the market may dictate that a particular mounting job cost approximately $100. If the listed price for mounting is grossly over or under this market price, the price may be modified. These changes may be also be stored in the database 15 for use in employee evaluations.

Once the final invoice prices are set, the billing department employee may print the final invoice with the billing department module 84. This invoice may then be transferred to the shipping department for inclusion in the final shipped package. Once a final invoice is printed, the status of the project as identified in the database 15 is changed to “invoiced.” The billing department module 84 is preferably configured to export the billing information (e.g., billing amount, customer number, job number, payment schedule, etc . . . ) for processing by an accounting program utilized by the platemaker's accounting department.

It should be apparent that the above described modules are illustrative of an exemplary embodiment of the job processing module 56. However, the functions of some or all of the modules may be combined in some of the listed modules. For example, the art department employee module may also verify that the art department employee prepare the printcard, if that is part of the art department employee's job. In essence though, the modules are designed to aid individual departments or people, whichever or whoever they may be, that have responsibilities in the flexographic platemaking process. It should also be understood that manufacturing systems may vary from platemaker to platemaker, but the modules of the job processing module 56 may be modified to track a particular platemaker's system while adhering to the general function of the modules described above. Job and customer data are registered into a database 15. This data may then be used by modules which are configured to display job order information to individual employees and to simplify tracking of time and material costs. The modules also provide quality control checklists that require an employee to verify that certain tasks have been completed before the job order is routed to a selected employee or department for action. These checklists may be generated, at least in part, based on customer and job data entered in a job entry module 54.

As mentioned above, FIG. 11 is a flow chart illustrating possible work flow paths for an exemplary flexographic plate manufacturing process that utilizes the employees and departments described above. However, it should be apparent that the modules of the job processing module 56 may be configured to conform to manufacturing systems the delegate employee and departmental responsibilities in other manners. Further, task lists and job requirements that employees must confirm, as well as job information entered in the database 15 may vary from platemaker to platemaker.

As mentioned above in connection with FIG. 3, an employee may also select a status reports module 58 after the employee login module 50. Because all of the job orders are preferably entered into the database 15 through job entry module 54, the status reports module 58 allows individuals or departments to generate a variety of status reports for individual employees, departments, and customers from database 15. This is particularly helpful in identifying projects that are currently the responsibility of the individual or department or soon will be the responsibility of the individual or department (e.g., the project will be released to the department or employee), in evaluating and meeting deadlines and overtime requests, and generally in managing employee resources. Customer status reports may also be generated for individual customers. Further, customer pricing reports may be generated to display job quotes for active, non-invoiced jobs.

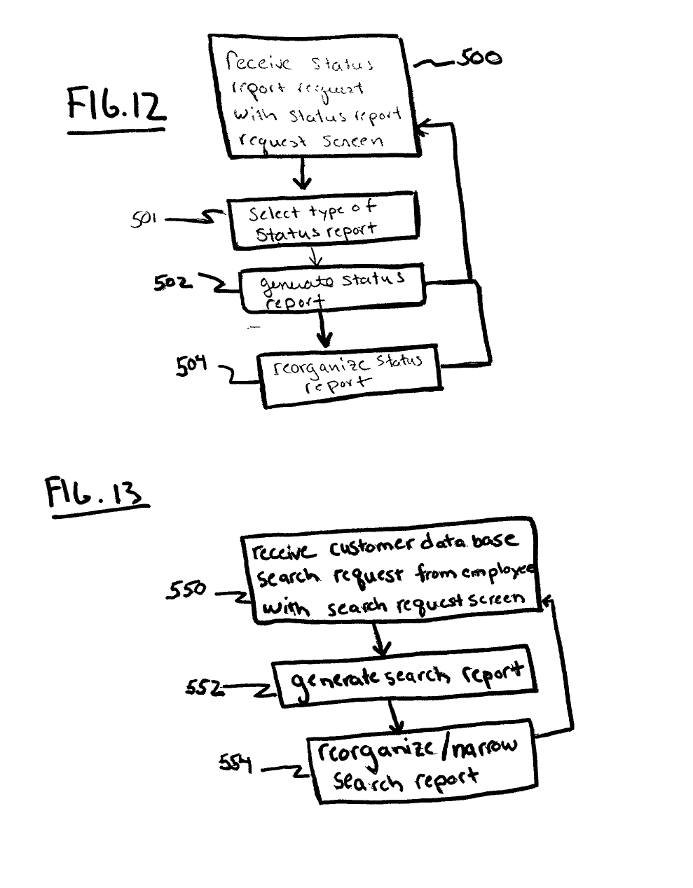

An exemplary status report module 58 functions as shown in FIG. 12. The status report module 58 displays a status report request screen on a monitor connected to an employee terminal 17. The status report module 58 receives a status report request from an employee through the status report request screen at step 500. The status report module 58, and therefore the status report screen, preferably provides the employee with a plurality of different limiting parameters, such as company name, shipping address, sales representative, job order creation date, proof date, proof revision date, delivery date, mounting date, job description, department to which the job order had been routed, status as “invoiced” or combination thereof. Once a request for a status report is received along with the limiting parameters, the status report module 58 preferably prompts the employee to select a type of status report to be generated at step 502. The status report is then generated at step 504 from a search of the data in the database 15 and displays the results to the employee, such as in a printout or on a monitor of an employee terminal 17. The job orders retrieved from the database 15 are selected according the parameters received at step 500, but the form of the report is dictated by the selection at step 502.

Once possible status report form that may be selected at step 502 includes a production status report or progress report. This report preferably lists information of interest to platemaker employees for each retrieved and listed job order, including company name, job description, platemaker job file number, shipping address, deadlines, etc . . . A second possible status report form that may be selected at step 502 includes a customer report form. The status report should list information of interest to a customer, such as the customer's project name, the customer's order date, the job description, proof delivery date and delivery method, final product delivery date and method, shipping address, and quote for the job order. The report should also be addressed to an employee of the customer from an employee of the platemaker. A third possible status report that may be selected at step 502 includes a customer pricing status report. This status report simply includes a price quote retrieved from database 15 for each job order identified by the parameters selected at step 500.

The status report module 58 also preferably provides the user the option at step 504 of reorganizing or sort the job order list generated in the status report. For example, the list may be reorganized by company, by job file number, by sales representative, by job order entry or creation date, by delivery date, or by the current status or substatus of the job order.

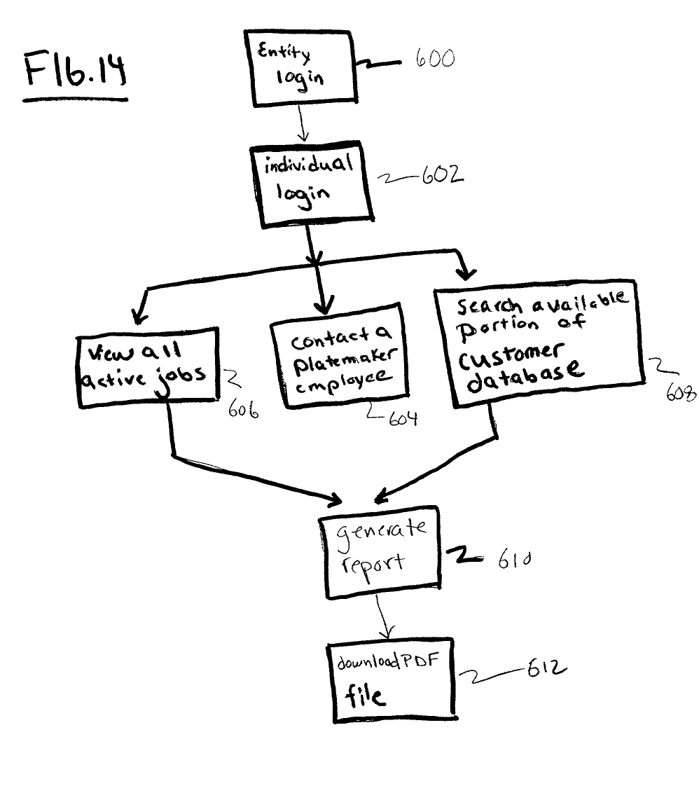

The order and job processing application also preferably includes a customer database search module 52 that may operate as shown in FIG. 13. The search module 52 functions much like the status report module 58, only is preferably provides the employee greater latitude in selecting search parameters. The search module 52 preferably generates a search screen that allows the employee to select from a number of search parameter. The parameters may include any of the types of customer or job data entered in the job entry module 54. The search module 58 preferably allows the employee to select more than one parameter, and search using Boolean methodology, i.e., AND and OR searching. After the search parameters are received by the search module at step 550, the search module generates a search report 552 listing the job orders satisfying the search request. The job orders may be listed in a default order, such as by customer name. This order may be reorganized at step 554 or the search parameters may be narrowed. Of course, the employee may select a new search at step 550. The generated search report preferably lists some, but not all of the information pertaining to the retrieved job orders, such as the information included in the production and progress status reports described above. Additional job order data contained in the database 15 for the retrieved job orders may be available by selecting an individual retrieved job order from the search report.

An exemplary old non-invoiced module 60 is an extension of the customer database search module 52. The module preferably provides the user an option to select a date range, such as Jan. 1, 2001-Jan. 31, 2001. The module then generates a report listing all job orders created between those dates that do not have the status of “invoiced” and, therefore, that are not yet completed by the platemaker. The report may be used to insure that the platemaker is staying current with its ob orders. The module may also be configured to narrow the search parameter by, for example, limiting the report to a specific company.

Once data pertaining to a job order is entered into a database 15, the customer interface module 24 (shown in FIG. 2) may be utilized by customers to access selected data in the database 15 pertaining to “active” jobs—jobs presently being worked on by the platemaker-or “closed” jobs—jobs already completed by the platemaker and paid in full by the customer. Customer access to data relating to a job order is preferably limited according to the type of customer. For example, a converter customer may be granted access to information pertaining only to jobs that indicate that the converter placed the job order or that indicate that the converter is the shipping address of a job order placed by another customer. A customer that is a buyer for a company is preferably only granted access to information pertaining to job orders which the buyer placed on behalf of a product manufacturer. A customer that is a product manufacturer should be granted access to information pertaining to all job orders being handled by the platemaker regardless of whether the job order was placed by the product manufacturer directly or through a buyer or converter on behalf of the product manufacturer.

As described in connection with FIG. 1, the customer interface module 24 may be programmed and stored on server 13 and be accessed by a customer terminal 21 through Internet 28. The interface module 24 is preferably accessible through the platemaker's webpage. In this manner, webpages prompting customer input and responding to customer requests are transmitted to a customer terminal 21 through Internet 21 in a conventional manner. The transmitted webpages may be made interactive if programming languages such as Javascript and programming applets are utilized. The function of the customer interface module 24 is described below in connection with FIG. 14.

An exemplary interface module 24 presents the customer with a first login screen at step 600. At this screen, a company name and company password are entered. The webpage preferably uses an encryption scheme to ensure that the transmission of the company name and password are secure. One exemplary scheme available is the WEBSTAR Secure Socket Layer (SSL) Protocol, ISOX.509 Certified. Once the company name and password are verified, the interface module preferably requires that the customer employee enter a personal user name and password at step 602. This feature adds an added layer of security, as well as allows the interface module 24 to distinguish between customer employees using the system. The data from the database 15 that is available to an individual may be determined both on the customer level and the employee level as desired by the customer and the platemaker.

The customer interface module 24 is preferably configured to allow the customer to choose at step 604 to contact a platemaker employee. If the customer chooses this option, the customer interface module 24 generates an email screen. The customer can then type an email to the selected platemaker employee. The message is received by the customer interface module 24 after the customer selects the “send” option, and the customer interface module 24 then forwards the message to the selected employee's email account.

An exemplary customer interface module 24 is also configured to allow the customer to access all “active” jobs of the customer currently within the platemaker manufacturing process. This feature is similar to the customer status report feature of the status report module 58 of the order and job processing application 22. If the customer selects this option at step 606, a report listing all of the customer's active jobs is generated for the customer at step 610 and transmitted to the customer terminal 21 through Internet 23. For example, a customer product manufacturer may be provided a list of all of the jobs that it ordered directly from the platemaker and all jobs ordered on its behalf by its buyer and converters. A converter customer is provided a list of all jobs that it ordered from the platemaker and all indirect business it is to receive—those jobs which identify the converter as the shipping address. Similarly, the buyer customer is provided a list of all of the active jobs that it ordered directly from the platemaker.

The report preferably lists the date the job was ordered, the platemaker job number, the job description, the scheduled delivery date, the scheduled proof date, the shipping address, and the status. The status may indicate, for example, that the job is in the art department, in the polymer department, in the vulcanizing department, in the engraving department, in the camera department, in the printcard department, in the mounting department, in the shipping department, or “invoiced.” All of this information is retrievable from database 15 as a result of the “routing” function of the modules of the job processing module 56. More detailed information than that listed above in the report (e.g., selected information pertaining to the job order contained in the database 15 but not listed in the report) may be obtained by double “clicking” on the listed project or by other suitable request method. If the job order status is “invoiced,” a color picture of a foldable box profile including the proofed design that may be created using the ordered plate(s) is also displayed when the customer requests more detailed information. The color picture is also preferably downloadable as a PDF (Portable Document Format) file at step 612.

The customer may also choose to search the portion of the database 15 available to the customer at step 608. The customer interface module 24 preferably presents the customer with a list of possible search parameters. When a search parameter or parameters is selected by the customer and transmitted to the interface module 24, the interface module searches the database 15 and generates a search report at step 610. This report is then transmitted to the customer terminal 21 for display. The search parameters may include any indicia entered in the job entry module 54, but preferably the searches utilize the broader indicia such as words contained in the job description, invoice numbers, job numbers, shipping addresses, company names, etc . . .

The report generated at step 610, whether generated as a result of a selection at step 606 to view information pertaining to all active jobs or a selection at step 608 to view information pertaining to selected jobs, may preferably be reorganized or narrowed by the user. The report, depending upon the customer and the request, may be quite lengthy. The customer interface module 24, therefore, preferably provides the user the ability to reorganize the report by, for example, listing the jobs according to specific displayed indicia (e.g., by status or shipping address) and provides the user the option of narrowing the report by, for example, eliminating groups of listed jobs orders (e.g., further limiting the report to all “invoiced” jobs). This may be accomplished by transmitting a modified list to the customer terminal through Internet 23 or by transmitting an applet, such as a Javascript applet, along with the generated report which allows the user to locally reorganize or narrow the report. Of course, the customer could also submit a new search request with additional limiting parameters at step 608 or initially specify a selected organization at step 606 before the report is generated at step 610.

It should be apparent that the customer interface module 24 provides several benefits to a platemaker's customers and the platemaker itself that are not available when the primary record keeping system of the platemaker utilizes paper job orders. Status inquiries to customer representative of the platemaker are all but eliminated, thereby freeing platemaker employee time. Archival responsibilities and tracking responsibilities are centralized in the platemaker, thereby freeing customer resources. Preferred customers may be selectively provided a powerful tool for identifying the status of individual projects. Proof and delivery dates may be easily verified, and a picture of a completed display or container may be printed, viewed on line, or downloaded in a PDF format. Further, the customer is provided a list of email contacts should the need for direct communication with a platemaker employee arise.

The present invention can be embodied in the form of methods and apparatus for practicing those methods. The present invention can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

Although the invention has been described in terms of exemplary embodiments, it is not limited thereto. Rather, the appended claims should be construed broadly to include other variants and embodiments of the invention that may be made by those skilled in the art without departing from the scope and range of equivalents of the invention.

What is claimed is:

1. A method of processing and managing a plurality of job orders for a plurality of flexographic plates being manufactured via a flexographic plate manufacturing process, said flexographic plate manufacturing process including a plurality of stages, each stage of said plurality of stages being characterized by at least one quality control requirement that is verified by at least one employee entity, the method comprising the steps of:
storing in a database customer data and job specification data for each of said plurality of job orders;
storing in said database a status indicator for each of said plurality of job orders, said status indicator identifying a stage from said plurality of stages in which each of said plurality of job orders respectively is pending;
receiving, through an employee terminal and for a job order selected from said plurality of job orders, confirmation for at least one of said plurality of stages that said at least one quality control requirement has been verified for said at least one of said plurality of stages;
receiving, through an employee terminal and for said job order selected from said plurality of job orders, a routing command to rout said job order selected from said plurality of job orders to an employee entity after receiving said confirmation; and
updating said status indicator for said job order selected from said plurality of job orders to indicate said employee entity identified in said routing command.

2. The method of claim 1, further comprising the steps of tracking work time spent by an employee entity on a job identified by said job order selected from said plurality of job orders and storing time data identifying said work time spent in said database.

3. The method of claim 1, further comprising the steps of receiving material data identifying materials and amounts of materials used by an employee entity on a job identified by said job order selected from said plurality of job orders and storing said material data in said database.

4. The method of claim 1, further comprising the steps of receiving a search request for said data stored in said database and identifying any job orders from said plurality of job orders satisfying said search request.

5. The method of claim 1, further comprising the steps of tracking work time spent by an employee entity on a job identified by said job order selected from said plurality of job orders, storing time data identifying said work time spent in said database, receiving material data identifying materials and amounts of materials used by an employee entity on said job identified by said job order selected from said plurality of job orders, and storing said material data in said database.

6. The method of claim 5, further comprising the step of generating a customer invoice for said job order selected from said plurality of job orders at least in part from said time and material data stored in said database.

7. The method of claim 1, wherein said step of receiving said routing command includes the step of prompting an employee entity through said employee terminal to select said employee entity to which said job order is to be routed from a list of a plurality of employee entities.

8. The method of claim 7, wherein said list of employee entities includes an art department employee, an art director, a production coordinator, a camera department, a polymer department, a vulcanizing department, a mounting department, a mounting coordinator, an engraving department, a printcards department, a shipping department, a billing department, or a combination thereof.

9. The method of claim 1, wherein said step of receiving confirmation for said at least one of said plurality of stages includes the step of prompting an employee entity through said employee terminal to identify each quality control requirement that has been verified by said employee entity.

10. The method of claim 9, further comprising the step of storing confirmation data in said database, said confirmation data identifying each quality control requirement identified by said employee entity.

11. The method of claim 1, wherein said customer data includes customer name, customer address, customer shipping address, customer number, customer pricing level, customer billing terms, customer contact information, or a combination thereof and wherein said job specification data includes job number, press specification data, plate specifications, plate delivery date, plate delivery method, proof delivery date, proof type, proof delivery method, proof delivery date, proof delivery revision date, sales representative identification, job title, job description, printcard requirement, printcard colors, plotting requirements, design specification, customer project name, customer item description, customer form number, customer product number, or a combination thereof.

12. The method of claim 1, further comprising the step of providing access to at least one customer through a computer network to data stored in said database.

13. The method of claim 1, wherein said step of providing access to said at least one customer includes the step of receiving a search request for said database, identifying job orders from said plurality of job orders associated with said at least one customer that satisfy said search request, and transmitting a report identifying said job orders that satisfy said search request to a customer terminal through said computer network.

14. A server for processing and managing a plurality of job orders for a plurality of flexographic plates being manufactured via a flexographic plate manufacturing process, said flexographic plate manufacturing process including a plurality of stages, each stage of said plurality of stages being characterized by at least one quality control requirement that is verified by at least one employee entity, the server comprising:
means for storing in a database customer data and job specification data for each of said plurality of job orders;
means for storing in said database a status indicator for each of said plurality of job orders, said status indicator identifying a stage from said plurality of stages in which each of said plurality of job orders respectively is pending;
means for receiving, through an employee terminal and for a job order selected from said plurality of job orders, confirmation for at least one of said plurality of stages that said at least one quality control requirement has been verified for said at least one of said plurality of stages;
means for receiving, through an employee terminal and for said job order selected from said plurality of job orders, a routing command to rout said job order selected from said plurality of job orders to an employee entity after receiving said confirmation; and
means for updating said status indicator for said job order selected from said plurality of job orders to indicate said employee entity identified in said routing command.

15. The server of claim 14, further comprising means for receiving a search request for said data stored in said database and identifying any job orders from said plurality of job orders satisfying said search request.

16. The server of claim 14, further comprising means for tracking work time spent by an employee entity on a job identified by said job order selected from said plurality of job orders, means for storing time data identifying said work time spent in said database, means for receiving material data identifying materials and amounts of materials used by an employee entity on said job identified by said job order selected from said plurality of job orders, and means for storing said material data in said database.

17. The server of claim 16, further comprising means for generating a customer invoice for said job order selected from said plurality of job orders at least in part from said time and material data stored in said database.

18. The server of claim 14, wherein said means for receiving said routing command includes means for prompting an employee entity through said employee terminal to select said employee entity to which said job order is to be routed from a list of a plurality of employee entities.

19. The server of claim 18, wherein said list of employee entities includes an art department employee, an art director, a production coordinator, a camera department, a polymer department, a vulcanizing department, a mounting department, a mounting coordinator, an engraving department, a printcards department, a shipping department, a billing department, or a combination thereof.

20. The server of claim 14, wherein said means for receiving confirmation for said at least one of said plurality of stages includes means for prompting an employee entity through said employee terminal to identify each quality control requirement that has been verified by said employee entity and means for storing confirmation data to said database, said confirmation data identifying each quality control requirement identified by said employee entity.

21. The server of claim 14, wherein said customer data includes customer name, customer address, customer shipping address, customer number, customer pricing level, customer billing terms, customer contact information, or a combination thereof and wherein said job specification data includes job number, press specification data, plate specifications, plate delivery date, plate delivery method, proof delivery date, proof type, proof delivery method, proof delivery date, proof delivery revision date, sales representative identification, job title, job description, printcard requirement, printcard colors, plotting requirements, design specification, customer project name, customer item description, customer form number, customer product number, or a combination thereof.

22. The server of claim 14, further comprising means for providing access to at least one customer through a computer network to data stored in said database and means for receiving a search request for said database, means for identifying job orders from said plurality of job orders associated with said at least one customer that satisfy said search request, and means for transmitting a report identifying said job orders that satisfy said search request to a customer terminal through said computer network.

23. A computer-readable medium encoded with a computer program for processing and managing a plurality of job orders for a plurality of flexographic plates being manufactured via a flexographic plate manufacturing process, said flexographic plate manufacturing process including a plurality of stages, each stage of said plurality of stages being characterized by at least one quality control requirement that is verified by at least one employee entity, the medium comprising:
a first code segment for storing in a database customer data and job specification data for each of said plurality of job orders;
a second code segment for storing in said database a status indicator for each of said plurality of job orders, said status indicator identifying a stage from said plurality of stages in which each of said plurality of job orders respectively is pending;
a third code segment for receiving, through an employee terminal and for a job order selected from said plurality of job orders, confirmation for at least one of said plurality of stages that said at least one quality control requirement has been verified for said at least one of said plurality of stages;
a fourth code segment for receiving, through an employee terminal and for said job order selected from said plurality of job orders, a routing command to rout said job order selected from said plurality of job orders to an employee entity after receiving said confirmation; and
a fifth code segment for updating said status indicator for said job order selected from said plurality of job orders to indicate said employee entity identified in said routing command.

24. The medium of claim 23, further comprising a sixth code segment for receiving a search request for said data stored in said database and identifying any job orders from said plurality of job orders satisfying said search request.

25. The medium of claim 23, further comprising a sixth code segment for tracking work time spent by an employee entity on a job identified by said job order selected from said plurality of job orders and for storing time data identifying said work time spent in said database and a seventh code segment for receiving material data identifying materials and amounts of materials used by an employee entity on said job identified by said job order selected from said plurality of job orders and for storing said material data in said database.

26. The medium of claim 25, further comprising a sixth code segment for generating a customer invoice for said job order selected from said plurality of job orders at least in part from said time and material data stored in said database.

27. The medium of claim 23, wherein said fourth code segment includes a code segment for prompting an employee entity through said employee terminal to select said employee entity to which said job order is to be routed from a list of a plurality of employee entities.

28. The medium of claim 23, wherein said third code segment includes a code segment for prompting an employee entity through said employee terminal to identify each quality control requirement that has been verified by said employee entity and means for storing confirmation data to said database, said confirmation data identifying each quality control requirement identified by said employee entity.

29. The medium of of claim 23, further comprising a sixth code segment for providing access to at least one customer through a computer network to data stored in said database, a seventh code segment for receiving a search request for said database, an eighth code segment for identifying job orders from said plurality of job orders associated with said at least one customer that satisfy said search request, and a ninth code segment for identifying said job orders that satisfy said search request to a customer terminal through said computer network.

30. A computer data signal embodied in a carrier wave encoded with computer program code for processing and managing a plurality of job orders for a plurality of flexographic plates being manufactured via a flexographic plate manufacturing process, said flexographic plate manufacturing process including a plurality of stages, each stage of said plurality of stages being characterized by at least one quality control requirement that is verified by at least one employee entity, the computer data signal comprising:
a first code segment for storing in a database customer data and job specification data for each of said plurality of job orders;
a second code segment for storing in said database a status indicator for each of said plurality of job orders, said status indicator identifying a stage from said plurality of stages in which each of said plurality of job orders respectively is pending;
a third code segment for receiving, through an employee terminal and for a job order selected from said plurality of job orders, confirmation for at least one of said plurality of stages that said at least one quality control requirement has been verified for said at least one of said plurality of stages;
a fourth code segment for receiving, through an employee terminal and for said job order selected from said plurality of job orders, a routing command to rout said job order selected from said plurality of job orders to an employee entity after receiving said confirmation; and
a fifth code segment for updating said status indicator for said job order selected from said plurality of job orders to indicate said employee entity identified in said routing command.

31. The computer data signal of claim 30 further comprising a sixth code segment for receiving a search request for said data stored in said database and identifying any job orders from said plurality of job orders satisfying said search request.

32. The computer data signal of claim 30, further comprising a sixth code segment for tracking work time spent by an employee entity on a job identified by said job order selected from said plurality of job orders and for storing time data identifying said work time spent in said database and a seventh code segment for receiving material data identifying materials and amounts of materials used by an employee entity on said job identified by said job order selected from said plurality of job orders and for storing said material data in said database.

33. The computer data signal of claim 32, further comprising a sixth code segment for generating a customer invoice for said job order selected from said plurality of job orders at least in part from said time and material data stored in said database.

34. The computer data signal of claim 30, wherein said fourth code segment includes a code segment for prompting an employee entity through said employee terminal to select said employee entity to which said job order is to be routed from a list of a plurality of employee entities.

35. The computer data signal of claim 30, wherein said third code segment includes a code segment for prompting an employee entity through said employee terminal to identify each quality control requirement that has been verified by said employee entity and means for storing confirmation data to said database, said confirmation data identifying each quality control requirement identified by said employee entity.

36. The computer data signal of claim 30, further comprising a sixth code segment for providing access to at least one customer through a computer network for said database, a seventh code segment for receiving a search request of said data stored in said database, an eighth code segment for identifying job orders from said plurality of job orders associated with said at least one customer that satisfy said search request, and a ninth code segment for identifying said job orders that satisfy said search request to a customer terminal through said computer network.

37. A method of providing to a customer through a computer network job order information, said job order information relating to at least one flexographic plate job order associated with said customer placed with a flexographic platemaker executing a flexographic plate manufacturing process, said flexographic plate manufacturing process including a plurality of stages, the method comprising:
storing in a database customer data and job specification data for a plurality of job orders;
maintaining in said database a status indicator for each of said plurality of job orders, said status indicator identifying a stage from said plurality of stages in which each of said plurality of job orders respectively is pending; and
providing through said computer network to at least one customer using a customer terminal access to at least a portion of said customer and job specification data for said at least one job order associated with said customer and access to said status indicator for said at least one flexographic plate job order associated with said customer.

38. The method of claim 37, wherein said customer data includes customer name, customer address, customer shipping address, customer number, customer pricing level, customer billing terms, customer contact information, or a combination thereof and wherein said job specification data includes job number, press specification data, plate specifications, plate delivery date, plate delivery method, proof delivery date, proof type, proof delivery method, proof delivery date, proof delivery revision date, sales representative identification, job title, job description, printcard requirement, printcard colors, plotting requirements, design specification, customer project name, customer item description, customer form number, customer product number, or a combination thereof.

39. The method of claim 37, wherein said step of providing access to said at least one customer includes the step of receiving a search request for said database, identifying job orders from said plurality of job orders associated with said at least one customer that satisfy said search request, and transmitting a report identifying said job orders that satisfy said search request to a customer terminal through said computer network.

40. The method of claim 37, further comprising the step of transmitting an image of a product having a design that may be printed with a plate associated with a selected job order from said plurality of job orders through said computer network to said customer terminal.

41. The method of claim 37, further comprising the step of transmitting a PDF file of an image of a product having a design that may be printed with a plate associate with a selected job order from said plurality of job orders through said computer network to said customer terminal.

42. The method of claim 37, further comprising the step of transmitting to said customer terminal through said computer network a list of all active job orders for said customer in response to a request for said list.

43. A server for providing to a customer through a computer network job order information, said job order information relating to at least one flexographic plate job order associated with said customer placed with a flexographic platemaker executing a flexographic plate manufacturing process, said flexographic plate manufacturing process including a plurality of stages, the server comprising:
means for storing in a database customer data and job specification data for a plurality of job orders;
means for maintaining in said database a status indicator for each of said plurality of job orders, said status indicator identifying a stage from said plurality of stages in which each of said plurality of job orders respectively is pending; and
means for providing through said computer network to at least one customer using a customer terminal access to at least a portion of said customer and job specification data for said at least one job order associated with said customer and access to said status indicator for said at least one flexographic plate job order associated with said customer.

44. The server of claim 43, wherein said customer data includes customer name, customer address, customer shipping address, customer number, customer pricing level, customer billing terms, customer contact information, or a combination thereof and wherein said job specification data includes job number, press specification data, plate specifications, plate delivery date, plate delivery method, proof delivery date, proof type, proof delivery method, proof delivery date, proof delivery revision date, sales representative identification, job title, job description, printcard requirement, printcard colors, plotting requirements, design specification, customer project name, customer item description, customer form number, customer product number, or a combination thereof.

45. The server of claim 43, wherein said means for providing access to said at least one customer includes means for receiving a search request for said database, identifying job orders from said plurality of job orders associated with said at least one customer that satisfy said search request, and transmitting a report identifying said job orders that satisfy said search request to a customer terminal through said computer network.

46. The server of claim 43, further comprising means for transmitting an image of a product having a design that may be printed with a plate associated with a selected job order from said plurality of job orders through said computer network to said customer terminal.

47. The server of claim 43, further comprising means for transmitting a PDF file of an image of a product having a design that may be printed with a plate associate with a selected job order from said plurality of job orders through said computer network to said customer terminal.

48. The server of claim 43, further comprising means for transmitting to said customer terminal through said computer network a list of all active job orders for said customer in response to a request for said list.

49. A computer-readable medium encoded with a computer program for providing to a customer through a computer network job order information, said job order information relating to at least one flexographic plate job order associated with said customer placed with a flexographic platemaker executing a flexographic plate manufacturing process, said flexographic plate manufacturing process including a plurality of stages, the medium comprising:
a first code segment for storing in a database customer data and job specification data for a plurality of job orders;
a second code segment for maintaining in said database a status indicator for each of said plurality of job orders, said status indicator identifying a stage from said plurality of stages in which each of said plurality of job orders respectively is pending; and
a third code segment for providing through said computer network to at least one customer using a customer terminal access to at least a portion of said customer and job specification data for said at least one job order associated with said customer and access to said status indicator for said at least one flexographic plate job order associated with said customer.

50. The medium of claim 49, wherein said customer data includes customer name, customer address, customer shipping address, customer number, customer pricing level, customer billing terms, customer contact information, or a combination thereof and wherein said job specification data includes job number, press specification data, plate specifications, plate delivery date, plate delivery method, proof delivery date, proof type, proof delivery method, proof delivery date, proof delivery revision date, sales representative identification, job title, job description, printcard requirement, printcard colors, plotting requirements, design specification, customer project name, customer item description, customer form number, customer product number, or a combination thereof.

51. The medium of claim 49, wherein said third code segment includes a code segment for receiving a search request for said database, for identifying job orders from said plurality of job orders associated with said at least one customer that satisfy said search request, and for transmitting a report identifying said job orders that satisfy said search request to a customer terminal through said computer network.

52. The medium of claim 49, further comprising a fourth code segment for transmitting an image of a product having a design that may be printed with a plate associated with a selected job order from said plurality of job orders through said computer network to said customer terminal.

53. The medium of claim 49, further comprising a fourth code segment for transmitting a PDF file of an image of a product having a design that may be printed with a plate associate with a selected job order from said plurality of job orders through said computer network to said customer terminal.

54. The medium of claim 49, further comprising a fourth code segment for transmitting to said customer terminal through said computer network a list of all active job orders for said customer in response to a request for said list.

55. A computer data signal embodied in a carrier wave encoded with computer program for providing to a customer through a computer network job order information, said job order information relating to at least one flexographic plate job order associated with said customer placed with a flexographic platemaker executing a flexographic plate manufacturing process, said flexographic plate manufacturing process including a plurality of stages, the computer data signal comprising:
a first code segment for storing in a database customer data and job specification data for a plurality of job orders;
a second code segment for maintaining in said database a status indicator for each of said plurality of job orders, said status indicator identifying a stage from said plurality of stages in which each of said plurality of job orders respectively is pending; and
a third code segment for providing through said computer network to at least one customer using a customer terminal access to at least a portion of said customer and job specification data for said at least one job order associated with said customer and access to said status indicator for said at least one flexographic plate job order associated with said customer.

56. The computer data signal of claim 55, wherein said customer data includes customer name, customer address, customer shipping address, customer number, customer pricing level, customer billing terms, customer contact information, or a combination thereof and wherein said job specification data includes job number, press specification data, plate specifications, plate delivery date, plate delivery method, proof delivery date, proof type, proof delivery method, proof delivery date, proof delivery revision date, sales representative identification, job title, job description, printcard requirement, printcard colors, plotting requirements, design specification, customer project name, customer item description, customer form number, customer product number, or a combination thereof.

57. The computer data signal of claim 55, wherein said third code segment includes a code segment for receiving a search request for said database, for identifying job orders from said plurality of job orders associated with said at least one customer that satisfy said search request, and for transmitting a report identifying said job orders that satisfy said search request to a customer terminal through said computer network.

58. The computer data signal of claim 55, further comprising a fourth code segment for transmitting an image of a product having a design that may be printed with a plate associated with a selected job order from said plurality of job orders through said computer network to said customer terminal.

59. The computer data signal of claim 55, further comprising a fourth code segment for transmitting a PDF file of an image of a product having a design that may be printed with a plate associate with a selected job order from said plurality of job orders through said computer network to said customer terminal.

60. The computer data signal of claim 55, further comprising a fourth code segment for transmitting to said customer terminal through said computer network a list of all active job orders for said customer in response to a request for said list.
